(19) United States
(12) Patent Application Publication
(10) Pub. No.: US 2004/0234429 A1
(43) Pub. Date: Nov. 25, 2004

(54) APPARATUS AND MEHTHOD FOR NEUTRALIZING TOXIC WASTE WATER AND DESTROYING ORGANIC COMPOUNDS

(76) Inventors: Larry V. Presley, Tampa, FL (US); Clarence S. Sanscrainte, Pompano Beach, FL (US)

Correspondence Address: GREENBERG & LIEBERMAN, 314 PHILADELPHIA AVE., TAKOMA PARK, MD, 20912, US

(21) Appl. No.: 10/710,518

(22) Filed: Jul. 16, 2004

Related U.S. Application Data
(63) Continuation-in-part of application No. 09/682,509, filed on Sep. 11, 2001.
(60) Provisional application No. 60/231,702, filed on Sep. 11, 2000.

(51) Int. Cl. B01J 19/08

(52) U.S. Cl. 422/186.3

(57) ABSTRACT

A hollow cylindrical tube runs the length of a photo-reactor. The tube is positioned below the photo-reactor or the photo-reactor sits atop the device. The cylindrical tube has a slotted opening on top. The photo-reactor fits into the slotted opening and is supported by the slotted opening. There is added reinforcement through the use of support braces on either side of the slotted opening along the cylindrical tube. These support braces are L-shaped and add strength and support to the upright plates sitting in the slotted opening. The support braces are aid in the attachment of the cylindrical tubing and the photo-reactor plates. The photo-reactor plates contain UV light once UV light has entered. Other parts of the present invention can be manufactured to contain UV light once UV light has entered, as well.

### CROSS REFERENCE TO RELATED APPLICATIONS

Priority is hereby claimed to Utility patent application Ser. No. 09/682,509 filed on Sep. 11, 2001, which claims priority to Provisional Patent Application 60/231,702 filed on Sep. 11, 2000.

### BACKGROUND OF INVENTION

The present invention relates to neutralizing toxic waste water, and more particularly, to effectively containing ultraviolet light within a photo-reactor plate to completely destroy any organic compound in the waste water.

Many companies and industries produce or use chemicals that are detrimental to the environment if released into the water systems or air without proper treatment. In the United States, we have series of environmental restrictions that require businesses to catalogue, diffuse and treat the volatile organic compound laden waste water before it is released into the environment, and is such restrictions are regulated by the Environmental Protection Agency. The use of photo-catalysis in volatile organic compound laden waste water management can alter the waste and eradicate it before the water reintroduction to the environment.

It is important to realize that sewage water can be cleaned in a variety of fashions, and the present invention is unconcerned with treating sewage water. Once sewage water has been treated, however, there is a need to remove harmful organic compounds and odors that still remain even after the sewage water has been effectively treated. When sewage water has been effectively treated, it is termed “waste water.” There is no effective apparatus or method to eradicate organic compounds and odors from treated sewage waste water and volatile organic compound laden waste water.

U.S. Pat. No. 5,924,437 issued to Young on Jul. 20, 1999, shows an External shutoff valve for fire hydrants. Young's invention is unlike the present invention because it is an emergency shut off valve method for fire hydrants that have been activated by accident, does not provide a means for treating or transporting volatile organic compound laden waste water, and does not provide for photo reaction plates or any photocatalysis means.

U.S. Pat. No. 5,615,703 issued to Kopp on Apr. 1, 1997, shows a plastic valve with inlet conduit extension. Kopp's invention is unlike the present invention because it has no means of attachment to a photo-reactor cell, it is not intended to expedite a volatile organic compound laden waste water purification system, and it has no described means for separating toxic components from benign components in volatile organic compound laden waste water.

U.S. Pat. No. 1,667,034 issued to Hatton, Jr. on Apr. 24, 1928, shows a sealing valve for gas lines. Hatton's invention is unlike the present invention because it has no means for attaching to a photo-reactor cell, and it is not intended for use in volatile organic compound laden waste water treatment.

U.S. Pat. No. 924,041 issued to Corlew on Jun. 8, 1909, shows a hose hydrant Corlew's invention is unlike the present invention because, it would not function for use in the photo-catalysis process, it does not have a means for treating volatile organic compound laden waste water to separate the toxic parts from the benign parts, and has a tapered end and no removable cap.

U.S. Pat. No. 4,095,115 issued to Orr, Jr. et al. on Jun. 13, 1978 describes tubing members, but is not concerned with maintaining ultraviolet light within a photo-reactor plate to destroy volatile organic compounds in waste water.

U.S. Pat. No. 5,397,444 issued to Zimek on Mar. 14, 1995 describes an apparatus for applying a corpuscular radiation to reactants initiating or perfecting chemical reactions. Unlike the present invention, Zimek's device is not concerned with maintaining ultraviolet light within a photo-reactor plate to destroy volatile organic compounds in waste water.

U.S. Pat. No. 6,165,423 issued to Crosbie on Dec. 26, 2000 describes interaction with reactants in an ozoniozer. Again, unlike the present invention, Crosbie's device is not concerned with maintaining ultraviolet light within a photo-reactor plate to destroy volatile organic compounds in waste water.

Therefore a need has been established for a method and apparatus for volatile organic compound laden waste water treatment via photocatalysis such that ultraviolet light is employed to destroy volatile organic compounds.

### SUMMARY OF INVENTION

A large problem throughout industrialization has been waste management. Heavy reliance throughout the years on pesticides and chemicals in agriculture and many other industries have caused industries and communities throughout the country to struggle with the treatment of volatile organic compound laden waste water. Processing volatile organic compound laden waste water in an environmentally sound and economical manner is of concern to many organizations. Photo-catalysis is a well known scientific process with a promising application in volatile organic compound laden waste water management. Photo-catalysis involves bombarding a photo-reactive compound with ultraviolet light. The compound becomes highly reactive; solar energy is converted into chemical energy through the transformation of the photo-reactive compound into reactive radicals. The highly reactive radicals attack oxidizable water pollutants by breaking their molecular bonds. Non toxic final products like water, carbon dioxide and weak acids are the end result.

A method for utilizing photo-catalysis in volatile organic compound laden waste water management is through the use of titanium dioxide as a photo-catalyst. Titanium dioxide is mixed in with the volatile organic compound laden waste water. This solution is processed through a series of flat plate photo-reactors. For optimum use of the photo-reactors, the solution should be evenly distributed over the flat plates. This would maximize the amount of solution in contact with the flat plate photo-reactors. To distribute the incoming solution from a piped source to the rectangular photo-reactors, an intermediary device is required. In the present invention, an intake flow of volatile organic compound laden waste water is channeled to photo-reactor plates, and the photo-reactor plates are made of a special compound to allow ultraviolet light to enter the photo-reactor plates, but not leave.

Definitions:

Photo-catalysis—to increase the rate of a chemical reaction induced by material unchanged chemically at the end of the reaction with ultra violet light as the energy source for the reaction

photo-catalyst—an agent which provokes or speeds up a reaction with ultra violet light as the energy source to activate the agent

photo-reactor—a device which creates a photochemical reaction

polymerizable—a chemical reaction in which two or more molecules combine to form larger molecules that contain repeating structural units

The present invention has a hollow cylindrical tube. The cylindrical tube runs the length of a photo-reactor. The tube is positioned below the photo-reactor or the photo-reactor sits atop the device. The cylindrical tube has a slotted opening on top. The photo-reactor fits into the slotted opening and is supported by the slotted opening. There is added reinforcement through the use of support braces on either side of the slotted opening along the cylindrical tube. These L-shaped braces add strength and support to the upright plates sitting in the slotted opening. The braces aid in the attachment of the cylindrical tubing and the photo-reactor plates.

Since fluids flow through the cylindrical tubing and the photo-reactor plates, a water tight seal is necessary between the tubing and the plates. A polymerizable cement and solvent is used in the slotted opening of the cylindrical tubing. This helps to create a water tight seal between the cylindrical tubing and the photo-reactor plates. The braces attached to the cylindrical tubing and the photo-reactor plates also help in creating a seal. With a water tight connection, fluid can flow through the tubing without contaminating the surrounding area.

Volatile organic compound laden waste water enters the cylindrical tubing from a piped source. One end of the cylindrical tube connects to this piped intake source. The volatile organic compound laden waste water flows through the cylindrical tube and fills the photo-reactor plates. The other end of the cylindrical tube acts as a blind end when plugged or can be hooked up in series with other tubing. A manifold at the top of the photo-reactor plates redistributes the processed water.

Accordingly, it is the object of the present invention to provide a system to optimize removal of toxins and volatile compounds from volatile organic compound laden waste water, and to do so via fluid flow to photo-reactor plates. Ultraviolet light is trapped in the photo-reactor plates so that toxins and volatile compounds can be eradicated.

### BRIEF DESCRIPTION OF DRAWINGS

FIG. 1 shows a cut away side view of the present invention.

FIG. 2 shows a top view of the manifold.

FIG. 3 shows a cut away section of the photo-reflector plate inserted into the manifold.

### DETAILED DESCRIPTION

Photo-catalysis is a well known process which occurs when an aqueous solution containing a hydrocarbon compound and a photo-catalyst agent such as titanium dioxide is exposed to ultraviolet rays. When the ultraviolet rays strike the titanium dioxide hydroxyl radicals are produced. The hydroxyl radicals interact with the hydrocarbons to produce carbon dioxide, water, and hydrochloric acid. Therefore, the photo-catalyst can break down volatile organic compound laden waste water into, benign, or recyclable compounds. In the present invention, chemical laden waste water is neutralized by use of a photo-reactor plate (50) and a photo-catalyst (not shown), and most importantly, the photo-reactor plate (50) allows ultraviolet light within it, but then traps the ultraviolet light so that the ultraviolet light is harnessed to destroy undesirable organic compounds.

The present invention is a device to not only direct the intake flow of volatile chemical laden waste water to a photo-reactor plate (50), but moreover, the present invention has a photo-reactor plate (50) that traps ultraviolet light. The present invention has, in its preferred embodiment, a cylindrical tube manifold (10) which is hollow. Along the apex of the tube is a slotted opening (30). A photo-reactive plate (50) sits in this slotted opening (30). Along the right side of the slotted opening (30) are supporting braces (35). The supporting braces are L-shaped. In the present invention, volatile chemical laden waste water is neutralized by use of the photo-reactor plate (50) and the photo-catalyst. The volatile chemical laden waste water is channeled into the photo-reactor plate (50) where the photo-catalyst and ultraviolet waves break down the volatile organic compound laden waste water. It is important to recognize that if the photo-reactor plate (50) allows ultraviolet light to escape, or literally pass through it, the present invention will not function properly, and will not effectively eradicate volatile chemical laden waste water. Thus, the photo-reactor plate (50) must only allow ultraviolet light within it, but not permit the ultraviolet light to leave. NOTE SOP AND PHOTO-REACTOR PLATE ARE THE SAME

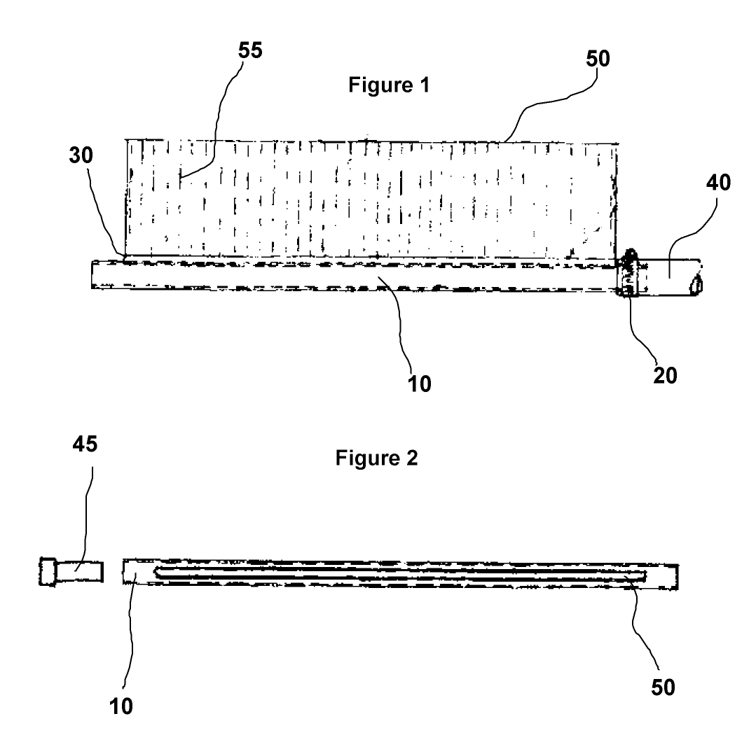

FIG. 1 shows a cut away side view of a possible embodiment of the present invention. The manifold (10) is manufactured of an Acrylic SOP of 16 wt, which is a double skinned acrylic sheet that is approximately 1200 mm wide. The acrylic sheets assist in maintaining even flow distribution through the channels (55) as shown. The photo-reactor plate (50) of the present invention is also made of an Acrylic SOP of 16 wt, which is a double skinned acrylic sheet that is approximately 1200 mm wide. Also the skin of the acrylic sheeting is so thin that the majority of UV radiation passes through the skin, and reacts with the titanium dioxide in the solution in the manifold (10) and photo-reactor plate (50), but the UV radiation cannot leave the manifold (10) and/or the photo-reactor plate (50). A 30 weight cement is used to seal the sheet to the manifold. At the end of the manifold (10) is a hose clamp (20) and flexible tubing (40).

The manifold (10) attaches to both ends of the acrylic sheet. At the opposite end of the manifold (10) from the flexible tubing (40) can be more flexible tubing or a cap (45) depending on desired use. If the use of more than one of the present invention is desired flexible tubing (40) will be attached to both ends and connected with one another. Cap (45) will only be used at the end of the last of the present inventions to be use regardless of the number used.

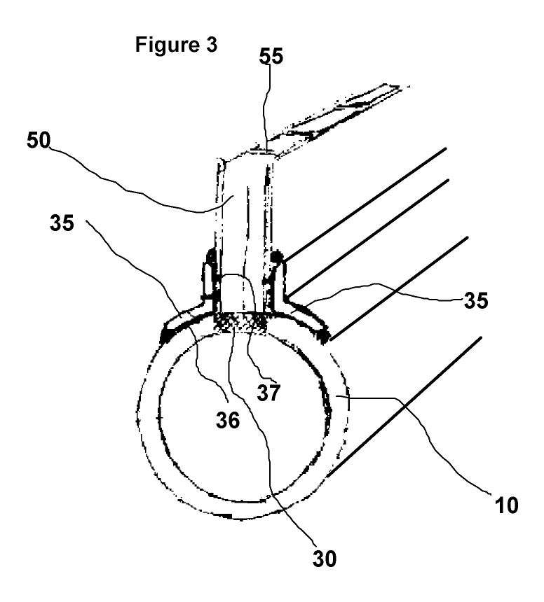

FIG. 2 shows a top view of the manifold and shows cap (45). Cap (45) has a notch (47) in it. Notch (47) lines up directly with slotted opening (30) and is for the photo-reflector plate (50) to sit in when cap (45) is inserted into manifold (10).

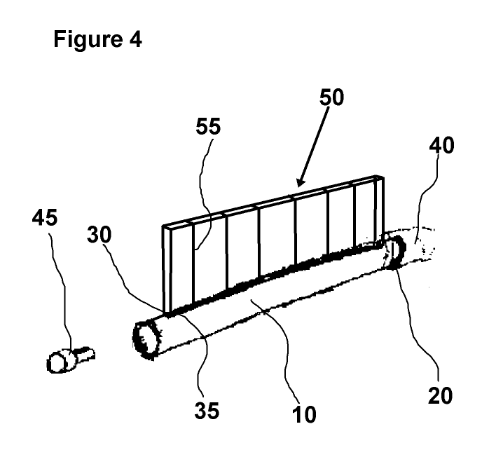

FIG. 3 displays the photo-reactor plate (50) seated in the slotted opening (30) in manifold (10). Support braces (35) are also shown attached to the manifold (10) and the photo-reactor plate (50). At the top of photo-reactor plate (50) is a closer view of the channels (55).

FIG. 4 shows the present invention and the steps for assembling such. The manifold (10) is shown at an approximate length of 54″. There is a cut away of each end of the manifold member of approximately 3″. There is a cap (45) shown that can attach to one end of the present invention. Cap (45) is made of a polyurethane material and is then inserted in the interior of the manifold, and in this embodiment is 6″ long. Around the center of the tubing is a groove of approximately 17 mm. There is a cement support at 3 and 47 inches to secure the manifold. The SOP is then inserted in one end of the pipe fashioned as a slot opening (30). This slot opening (30) acts as a flow header into the manifold (10). The end with the SOP is then cemented and welded.

The first side (36) of a supporting brace (35) is attached to the manifold (10). The second side (37) of a supporting brace (35) rests on the wall of the photo-reactor plate (50) once the plate (50) is placed in the slot opening (30) and is then welded in place. This procedure is mirrored on both sides of the photo-reactor plate (50). A suitable solvent and polymerized cement provide additional strength at this joint and a water tight seal between the surfaces. The supporting braces (35) are attached to the exterior of the manifold (10) so as to support and prevent damage to the photoreactive plate (50). The photo-reactor plate (50) is disposed above the manifold (10), and the support stresses and demands are different than a typical cylinder upon a cylinder. In addition, in the present invention, part of the photo-reactor plate (50) fits within a slotted opening (30) atop the manifold (10) there is a generally rectangular slotted opening (30) to receive the photo-reactor plate (50) in the manifold (10). The fitting of the photo reactor plate (50) in the slotted opening (30) adds to stability of the photo-reactive plate (50).

Volatile organic compound laden waste water from a piped in source enters the first end of the manifold (10). The first end of the manifold (10) fits the end of the piped source through standard piping connectors. The first end of the manifold (10) acts as a conduit for the volatile organic compound laden waste water. The volatile organic compound laden waste water can fill the photo-reactor plates (50). The first end of the manifold (10) acts as the intake point for volatile organic compound laden waste water to the system. The second end of the manifold (10) can be plugged with cap (45) or joined in a series with flexible tubing (40).

It is to be understood that the present invention is not limited to the sole embodiment described above, but should be interpreted in cover all embodiments within the scope of the following claims.

1. An apparatus for use for volatile organic compound laden waste water management and destroying organic compounds, comprising:
a main hollow body, having a first and second end;
a photo-reactor plate that traps UV light, placed in communication with said first end;
a series of bracing members attached to the exterior of said main hollow body so as to support and prevent damage to said photo-reactor plate;
a slotted opening in fixed communication with said first end to receive said photo-reactor plate; and
a series of tubing communicating with said second end of said main body.

2. The apparatus of claim 1, wherein said photo-reactor plate is made of Acrylic SOP of 16 wt, which is a double skinned acrylic sheet that is approximately 1200 mm wide.

3. The apparatus of claim 1, wherein said series of tubing is made of Acrylic SOP of 16 wt, which is a double skinned acrylic sheet that is approximately 1200 mm wide

4. An apparatus for use with volatile organic compound laden waste water management, comprising:
a main hollow body, having a first end and a second end, and configured to communicate with volatile organic compound laden waste water;
a photo-reactor plate that traps UV light, placed in communication with said first end,
a series of bracing members attached to the exterior of said main hollow body, said series of bracing members having curved bottoms and vertical upper portions;
a photo-catalyst, introduced into said volatile organic compound laden waste water, configured to communicate with said photo-reactor plate;
a slotted opening in fixed communication with said first end; and
a series of tubing communicating with said second end of said main body.

5. A method of neutralizing volatile organic compound laden waste water and destroying organic compounds, comprising:
running volatile organic compound laden waste water into a photo-reactor plate;
infusing the volatile organic compound laden waste water with a photo-catalyst;
penetrating the photo-reactor plate with ultraviolet light; and
preventing the ultraviolet light from escaping the photo-reactor plate.
